(19) United States
(12) Patent Application Publication
(10) Pub. No.: US 2023/0151151 A1
(43) Pub. Date: May 18, 2023

(54) NOVEL CO-POLYAMIDES

(71) Applicant: SOLVAY SPECIALTY POLYMERS USA, LLC, Alpharetta, GA (US)

(72) Inventors: Tanner Gerschick, Roswell, GA (US); Nancy J. Singletary, Alpharetta, GA (US); Joel Pollino, Johns Creek, GA (US)

(73) Assignee: SOLVAY SPECIALTY POLYMERS USA, LLC, Alpharetta, GA (US)

(21) Appl. No.: 17/802,892

(22) PCT Filed: Feb. 23, 2021
(86) PCT No.: PCT/EP2021/054427

§ 371 Date: Aug. 26, 2022

Related U.S. Application Data
(60) Provisional application No. 62/982,822, filed on Feb. 28, 2020.

(30) Foreign Application Priority Data
Jul. 2, 2020 (WO) 20183596.4

(51) Int. Cl. C08G 69/12; C08J 5/04

(52) U.S. Cl. CPC C08G 69/12; C08J 5/042; C08J 5/043

(57) ABSTRACT

The present invention relates to a of amide copolymer produced from a carboxy-piperidine, preferably 4-piperidinecar-boxylic acid and an aminoacid or lactam, preferably 4-aminomethyl-benzoic acid, to a process for its manufacture and to the use thereof for the manufacture of thermoplastic composites, and articles manufactured via injection molding, extrusion and through additive manufacturing technologies.

### CROSS-REFERENCE TO RELATED APPLICATIONS

This application claims priority to U.S. Provisional Application No. 62/982,822, filed on Feb. 28, 2020 and European application No. 20183596.4, filed on Jul. 2, 2020, the whole content of these applications being incorporated herein by reference for all purposes.

### TECHNICAL FIELD

The present invention relates to a novel polyamide polymer, to a process for its manufacture and to the use thereof for the manufacture of thermoplastic composites, and articles manufactured via injection molding, extrusion and through additive manufacturing technologies.

### BACKGROUND ART

Synthetic linear polyamides are generally prepared by condensation of substantially equimolar amounts of a diamine and a carboxylic acid, or its amide-forming derivatives or by the self-condensation of a relatively long chain amino acids or their amido-forming derivatives.

The mechanical properties of polyamides depend on their molecular weight and the constitution of their monomers, i.e. the selection of diamines and diacids.

U.S. Pat. No. 2,952,667 (Eastman Kodak Company, Rochester, N.Y.) discloses polyamides from 4-carboxy-piperidine (isonipecotic acid) and the preparation of these resinous materials. More in particular, the 4-carboxypiperidine was found capable of (I) self-condensing thus making homopolyamides and (II) co-condensing with various aminoacids or salts of dicarboxylic acids and diamines, in the proportion of at least 50 mole percent of the 4-carboxypiperidine component, the advantageous range being from 50-95 mole percent.

U.S. Pat. No. 3,297,655 (Francis E. Cislak) discloses polyamides characterized by recurring units of formula:

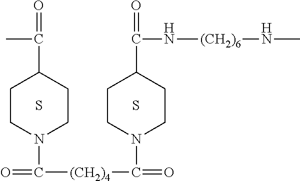

which are manufactured by reacting a bis-carboxypiperidine with a diamine. This reaction allows to obtain polyamide polymers having a strictly alternating recurring units.

U.S. Pat. No. 3,371,068 (Monsanto Company) discloses synthetic linear condensation polyamides obtained from the reaction of dipiperidyls with dicarboxylic acid chlorides. These polyamides contain recurring structural units of formula:

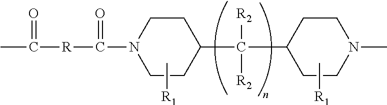

wherein n is an integer from 0 to 5 and R2 represent hydrogen or methyl.

More recently, WO 2019/121823 (Rhodia Operations) disclosed piperidine-containing semi-aromatic polyamide, comprising structural unit derived from piperidine and an aromatic diacid, having the following general formula (1):

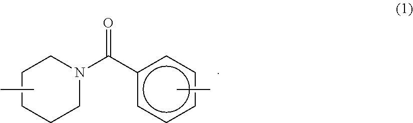

The semi-aromatic polyamide is obtained by polymerization of a diamine of formula (3):

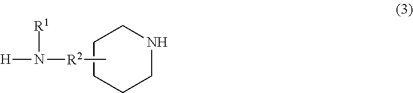

with an aromatic dicarboxylic acid or ester of formula (4):

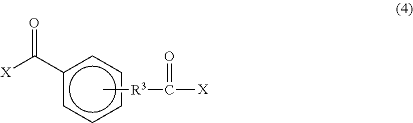

The same structural unit of formula (1) above was also disclosed in WO 2019/12182 and WO 2019/121826 (both in the name of Rhodia Operations). The above mentioned patent applications neither disclose nor exemplify co-polyamides obtained using the isonipecotic acid as co-monomer.

### SUMMARY OF INVENTION

Despite the large number of known polyamides, the Applicant perceived that there is still need for further improving the overall properties of these polymers.

Indeed, the Applicant faced the problem of providing a new polyamide characterized by good flow and processing properties, without negatively affecting its mechanical properties.

Thus, in a first aspect, the present invention relates to a polymer [polymer (PA)] comprising:
at least one recurring unit [R_{INP}] complying with the following formula:

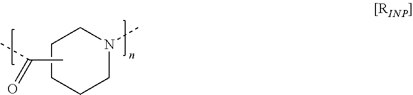

at least one recurring unit [R_{PA}] complying with the following formula:

[R_{PA}]—[HN-G^{III}(═O)]—

wherein

each of G^{I}, G^{II} and G^{III} is an optionally substituted linear or branched alkyl chain comprising from 1 to 16 carbon atoms, an optionally substituted cycloalkyl group comprising 6 carbon atoms, or an optionally substituted phenylene;

wherein said recurring unit(s) [R_{INP}] and said recurring unit(s) [R_{PA}] are randomly disposed along the backbone of said polyamide.

According to one preferred embodiment, said —C(═O)— group is in position 3 of the piperidine ring in formula [R_{INP}] above.

According to one preferred embodiment, said —C(═O)— group is in position 4 of the piperidine ring in formula [R_{INP}] above.

### DESCRIPTION OF EMBODIMENTS

As used in the present description and in the following claims: the dashed bond(s) [---] in the chemical formulae represent(s) a bond to an atom outside the drawn unit.

Advantageously, polymer (PA) comprises up to 50, preferably up to 49 mol. %, preferably up to 48 mol. %, more preferably up to 47 mol. % and even more preferably up to 45 mol. % of said recurring units [R_{INP}], the amount being relative to the total number of moles of recurring units in the polymer (PA).

Advantageously, polymer (PA) comprises at least 0.5 mol. %, preferably at least 1 mol. %, more preferably at least 1.5 mol. % and even more preferably at least 2 mol. % of said recurring units [R_{INP}], the amount being relative to the total number of moles of recurring units in the polymer (PA).

Advantageously, polymer (PA) comprises from 2 to 49 mol. %, preferably from 5 to 45 mol. %, more preferably from 10 to 40 mol. % of said recurring units [R_{INP}], the amount being relative to the total number of moles of recurring units in the polymer (PA).

Advantageously, polymer (PA) comprises at least 50 mol. %, preferably at least 51 mol. %, preferably at least 52 mol. %, more preferably at least 53 mol. % and even more preferably at least 55 mol. % of said at least one recurring unit [R_{PA}], the amount being relative to the total number of moles of recurring units in the polymer (PA).

Advantageously, polymer (PA) comprises up to 99.5 mol. %, preferably up to 99 mol. %, more preferably up to 98.5 mol. % and even more preferably up to 98 mol. % of said at least one recurring unit [R_{PA}], the amount being relative to the total number of moles of recurring units in the polymer (PA).

Advantageously, polymer (PA) comprises from 51 to 98 mol. %, preferably from 55 to 95 mol. %, more preferably from 60 to 90 mol. % of said at least one recurring unit [R_{PA}], the amount being relative to the total number of moles of recurring units in the polymer (PA).

Preferably, said recurring unit of formula [R_{PA}] is selected from the group comprising at least one divalent moiety complying with the following formulae:

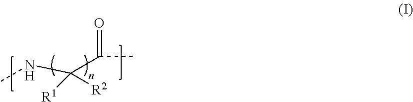

wherein

n is an integer from 1 to 15, preferably from 4 to 12, more preferably from 5 to 11,

R¹ and R² are independently selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium;

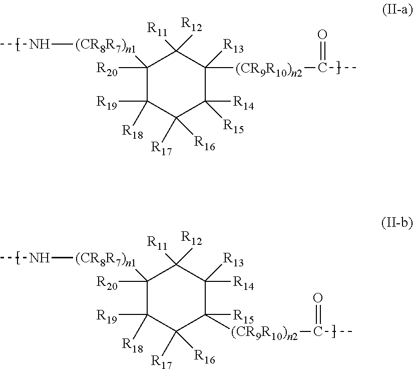

wherein

each of R₇ to R₂₀ is independently selected from hydrogen atom, halogen atom, alkyl, alkenyl, alkynyl, aryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium, each of n1 and n2, independently, is 0 or an integer from 1 to 12, preferably from 1 to 8, more preferably from 1 to 6;

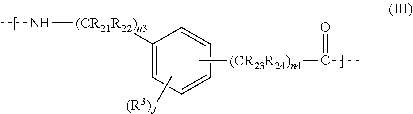

wherein

R³ is selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium,

J is 0 or an integer from 1 to 4,

each of R₂₁ to R₂₄ is independently selected from hydrogen atom, halogen atom, alkyl, alkenyl, alkynyl, aryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium, each of n3 and n4, independently, is 0 or an integer from 1 to 15, preferably from 4 to 12, more preferably from 5 to 11.

According to a preferred embodiment, said recurring unit of formula [R_{PA}] complies with formulae (II-a) or (II-b) above, wherein each of R₇ to R₂₀ is independently selected from hydrogen atom, halogen atom, alkyl group comprising from 1 to 3 carbon atoms and each of n1 and n2, independently, is 0 or an integer from 1 to 3.

Even more preferably, said recurring unit of formula [R_{PA}] complies with formulae (II-a) or (II-b) above, wherein each of R₇ to R₂₀ is hydrogen atom, n1 is 1 and n2 is 0.

According to another preferred embodiment, said recurring unit of formula [R_{PA}] complies with formula (III) above, wherein R³ is selected from hydrogen atom, halogen atom, alkyl group comprising from 1 to 3 carbon atoms, J is 0 or an integer from 1 to 4, each of R₂₁ to R₂₄ is independently selected from hydrogen atom, halogen atom, alkyl group comprising from 1 to 3 carbon atoms, and each of n3 and n4, independently, is 0 or an integer from 1 to 3.

Even more preferably, said recurring unit of formula [R_{PA}] complies with formula (III) above, wherein

R³ is selected from hydrogen atom, halogen atom, alkyl group comprising from 1 to 3 carbon atoms,

J is 0 or an integer from 1 to 4,

n3 is 1,

R₂₁ and R₂₂ are hydrogen atoms and

n4 is 0.

According to a preferred embodiment, said polymer (PA) comprises less than 50 mol. % of said recurring unit [R_{INP}] and more than 50 mol. % of one recurring unit [R_{PA}].

The molecular weight of the polymer (PA) is not particularly limited and can be preferably selected by the person skilled in the art depending on the final application for which polymer (PA) is intended.

Preferably, however, the number average molecular weight of polymer (PA) of the invention is at least 5000, as measured by gel permeation chromatography, as detailed in the experimental section.

Advantageously, polymer (PA) of the present invention shows a glass transition temperature (Tg) below 200° C., as determined by DSC analysis, as detailed in the experimental section.

Advantageously, polymer (PA) of the present invention shows a polydispersity (PD) in the range from 1.5 to 5.0.

Advantageously, polymer (PA) of the invention comprises recurring units [R_{INP}] deriving from nipecotic acid.

Preferably, said recurring units [R_{PA}] complying with formula (I) derive from a reactant selected in the group comprising, more preferably consisting of: 2-amino-4-methylpentanoic acid, 6-aminohexanoic acid, 10-aminodecanoic acid, 11-aminoundecanoic acid, 12-aminoundecanoic acid.

Preferably, said recurring units [R_{PA}] complying with formula (III) derive from a reactant selected in the group comprising, more preferably consisting of: 3-aminomethyl benzoic acid, 4-aminomethylbenzoic acid.

According to a preferred embodiment, said recurring units [R_{PA}] derive from 3-aminomethyl benzoic acid or 4-aminomethylbenzoic acid.

The person skilled in the art will understand that the reaction between said nipecotic acid and said at least one reactant proceeds via polycondensation reaction.

Advantageously, the reaction is performed in a solvent, which is preferably water.

Preferably, said polycondensation reaction is performed under heating, more preferably at a temperature higher than 100° C.

Preferably, said polycondensation reaction is performed at pressure higher than 0.1 MPa, more preferably higher than 0.5 MPa.

If required by the circumstances, polymer (PA) can also comprise at least one mono-functional compound selected from mono-amines, mono-anhydrides, monoacids as chain limiters, which are preferably selected in the group comprising phthalic anhydride, 1-aminopentane, 1-aminohexane, 1-aminoheptane, 1-aminooctane, 1-aminononane, 1-aminodecane, 1-aminoundecane, 1-aminododecane, benzylamine, acetic acid, propionic acid, benzoic acid, stearic acid or mixtures thereof.

The present invention further comprises a composition [composition (C)] comprising at least polymer (PA), in admixture with other additional ingredients selected reinforcing fibres and additives selected from the group comprising, preferably consisting of: UV stabilizers, heat stabilizers, pigments, dyes, flame retardants, impact modifiers, processing aids, nucleating agents, mineral fillers, and mixtures thereof.

Said reinforcing fibers are preferably selected in the group comprising carbon fibers, continuous or chopped glass fibers, synthetic polymeric fibres, aluminium fibres, aluminium silicate fibres, titanium fibres, steel fibres, silicon carbide fibres and boron fibers. Glass fibers and carbon fibers are particularly preferred.

If required by the circumstances, said composition can comprise a polymer different from polymer (PA) of the present invention.

Said polymer is preferably selected in the group comprising: aliphatic or semi-aromatic polyamides, polyester polymer, polyarylether sulfone polymer, polyaryl ether ketone polymer, polyarylene sulfide polymer, polyarylene ether polymer, liquid crystal polymer and combinations thereof.

Preferably, said composition (C) comprises from 10 to 99.9 wt. % of polymer (PA) of the invention, more preferably from 20 to 90 wt. %, and even more preferably from 25 to 85 wt. %, based on the total weight of the composition (C).

Preferably, said composition (C) is manufactured by contacting polymer (PA) of the invention, with the other additional ingredient(s), and processing them to the melting temperature of polymer (PA).

Said composition (C) can be prepared by hot mixing the above mentioned ingredients at a temperature allowing to keep the co-polyamide in the molten state. Alternatively, said composition (C) can be prepared by cold mixing.

Typically, after mixing, said composition (C) is further processed via an extruder, in to provide pellets.

Shaped articles can be advantageously manufactured using said composition (C) or said pellets, via moulding, including for example injection moulding, blow moulding, water moulding; extrusion; pelletizing.

Any type of shaped article can be manufactured using either the polymer (PA) or the composition (C) according to the present invention.

Advantageously, the shaped article obtained using the polymer (PA) of the invention shows biodegradability properties.

The present invention will be now explained in more detail by reference to the following examples, which are intended to represent the invention without limiting it.

### Experimental Section

Materials:

4-piperidinecarboxlic acid (also referred to as ‘hexahydroisonicotinic acid’, ‘isonipecotic acid’ and with the acronym ‘INP’) (CAS 498-94-2) was obtained from Aldrich. 4-(aminomethyl)benzoic acid was also obtained from Aldrich. 1,6-hexamethylenediamine; 1,10-decanediamine; 1,12-dodecanediamine; adipic acid; terephthalic acid were obtained from Aldrich.

Hexafluoroisopropanol (HFIP) was obtained from Oakwood Chemical. Sodium trifluoroacetate (NaFTA) was obtained from Acros Organics.

Methods:

Thermogravimetric analysis (TGA) was conducted under nitrogen according to the ASTM E2550.

Differential scanning calorimetry (DSC) analysis was conducted using a heating and cooling rate of 20° C./min according to the ASTM D3418. Glass transition and melting temperatures were determined from the second heat ramp results.

Gel permeation chromatography (GPC) was performed following an internal method, employing a WatersModular SEC Instrument, a Waters Alliance 2695 Separation Module, a Waters 2487 Dual Absorbance Detector, a Waters 2414 Refractive Index Detector, a Waters 515 pump and Waters Empower Pro Gel Chromatography Software. The instrument was equipped with two PL gel 10 μm MiniMixe B 250×4.6 mm columns and a guard column The samples were dissolved at 5 to 6 g/L in HFIP containing 0.05 M NaFTA; a 15 μl sample was injected. Elution was conducted as 40° C. Results were calibrated against a broad MW internal standard, AMODEL® 1000, M_{w}=27943, Mₙ=9340, M_{w}/Mₙ=2.99.

### Comparative Example 1C(*): INP Homo-Polyamide

A reactor was charged with 29.0 g (225 mmol) isopinecotic acid, 12 g water and 19.9 mg (0.242 mmol) phosphorous acid.

A nitrogen purge was conducted and then the reactor was heated to a temperature of 238° C. and a pressure of 300 psig (2.068 MPa). Pressure was controlled by distillation at 300 to 280 psig (2.068 to 1.931 MPa) and temperature increased to 282° C. over a period of 30 minutes. Pressure was lowered to atmospheric over a span of 30 minutes as temperature was increased to 288° C. A nitrogen sweep was conducted for 15 minutes.

The polymer was produced as a porous, crumbly cream-colored solid. Sublimed monomer was present on the interior surface of the reactor head.

Thermogravimetric analysis under nitrogen showed a 3.8% loss of moisture below 200° C. and the onset of degradation occurs at 451° C.

### Comparative Example 2C(*)

A reactor was charged with 38.8 g (257 mmol) 4-(aminomethyl)benzoic acid, 7.53 g (64.8 mmol) hexamethylenediamine, 10.7 g (64.2 mmol) terephthalic acid, 25 g water and 39.7 mg (0.484 mmol) phosphorous acid.

A nitrogen purge was conducted and then the reactor was heated to a temperature of 262° C. and a pressure of 350 psig (2.413 MPa). Pressure was controlled by distillation at 350 psig (2.413 MPa) for 30 minutes as temperature was increased to 265° C. Pressure was lowered to atmospheric over a period of 35 minutes as temperature was increased to 282° C. Temperature was maintained under steam atmosphere for 10 minutes.

### Comparative Example 3C(*)

A reactor was charged with 16.4 g (109 mmol) 4-(aminomethyl)benzoic acid, 5.68 g (48.9 mmol) hexamethylenediamine, 6.80 g (46.6 mmol) adipic acid, 14 g water and 19.9 mg (0.242 mmol) phosphorous acid.

A nitrogen purge was conducted and then the reactor was heated to a temperature of 216° C. and a pressure of 350 psig (2.413 MPa). Pressure was controlled by distillation at 350 psig (2.413 MPa) for 25 minutes as temperature was increased to 266° C. Pressure was lowered to atmospheric over a period of 45 minutes as temperature was increased to 282° C. Temperature was maintained under steam atmosphere for 10 minutes.

### Example 4

A reactor was charged with 7.65 g (59.3 mmol) isopinecotic acid, 20.9 g (138 mmol) 4-aminomethylbenzoic acid, 12 g water and 19.9 mg (0.242 mmol) phosphorous acid.

A nitrogen purge was conducted and then the reactor was heated to a temperature of 260° C. and a pressure of 325 psig. Pressure was controlled by distillation at 325 psig and temperature increased to 276° C. over a period of 30 minutes. Pressure was lowered to atmospheric over a span of 45 minutes as temperature was increased to 283° C. A nitrogen sweep was conducted for 15 minutes.

The polymer was produced as a transparent yellow solid.

Thermogravimetric analysis under nitrogen showed a temperature of 397° C. at 5% weight loss and a degradation onset temperature at 405° C.

Thermal properties and molecular weight were evaluated for each co-polyamide prepared following the procedures described above and the results are reported in Table 1 below.

TABLE 1

| | 1C(*) | 2C(*) | 3C(*) | 4 |
|---|---|---|---|---|
| INP | 100 | — | — | 30 |
| 4-AMBa | — | 67 | 54 | 70 |
| Hexamethylene diamine | — | 16.5 | 23 | — |
| Terephthalic acid | — | 16.5 | — | — |
| Adipic acid | — | — | 23 | — |

Themal properties and polidispersity (PD)

| | | | | |
|---|---|---|---|---|
| Tg (° C.) | >400 | 162 | 128 | 217 |
| Tm (° C.) | >400 | — | — | — |
| Mₙ | 4300 | 2700 | 5600 | 9600 |
| M_{w} | 5900 | 37000 | 17000 | 34000 |
| PD (M_{w}/Mₙ) | 1.38 | 13.7 | 2.97 | 3.54 |

(*)comparison

The above results showed that the polyamide according to the present invention polymerized to a molecular weight useful for mechanical properties, while the narrow polydispersity contributed to good flow of the melt during article manufacture. The high Tg of Example 4 also showed a benefit in the performances of the final articles obtained therefrom, in high heat and humidity environments.

In contrast, the compositions of the comparative examples showed impractical thermal properties. In Comparative Example 1C(*), a poor conversion was achieved, with number average molecular weight not acceptable from mechanical propertie perspective. In Comparative Example 2C(*), a very high polydispersity (PD) was obtained, suggesting a high level of branching, which is not desired.

Should the disclosure of any patents, patent applications, and publications which are incorporated herein by reference conflict with the description of the present application to the extent that it may render a term unclear, the present description shall take precedence.

1. A polymer [polymer (PA)] comprising:
at least one recurring unit [R_{INP}] complying with the following formula: 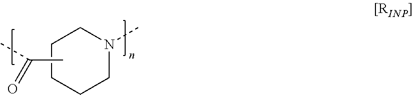
at least one recurring unit [R_{PA}] selected from:
[R_{PA}]—[HN-G^{III}-C(═O)]—
wherein
each of G^{I}, G^{II} and G^{III} is an optionally substituted linear or branched alkyl chain comprising from 1 to 16 carbon atoms, an optionally substituted cycloalkyl group comprising 6 carbon atoms, or an optionally substituted phenylene; wherein said recurring unit(s) [R_{INP}] and said recurring unit(s) [R_{PA}] are randomly disposed along the backbone of said polyamide.

2. The polymer (PA) according to claim 1, wherein said —C(═O)— group is in position 3 or in position 4 of the piperidine ring in formula [R_{INP}].

3. The polymer (PA) according to claim 1, said polymer (PA) comprising up to 50 of said recurring units [R_{INP}], the amount being relative to the total number of moles of recurring units in the polymer (PA).

4. The polymer (PA) according to claim 3, said polymer (PA) comprising from 2 to 49 mol. % of said recurring units [R_{INP}], the amount being relative to the total number of moles of recurring units in the polymer (PA).

5. The polymer (PA) according to claim 1, said polymer (PA) comprising at least 50 mol. % of said at least one recurring unit [R_{PA}] and up to 99.5 mol. % of said at least one recurring unit [R_{PA}], the amount being relative to the total number of moles of recurring units in the polymer (PA).

6. The polymer (PA) according to claim 5, said polymer (PA) comprising from 51 to 98 mol. % of said at least one recurring unit [R_{PA}], the amount being relative to the total number of moles of recurring units in the polymer (PA).

7. The polymer (PA) according to claim 1, wherein said recurring unit of formula [R_{PA}] is selected from the group comprising at least one divalent moiety complying with the following formulae: 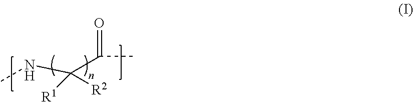
wherein
n is an integer from 1 to 15, R¹ and R² are independently selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium; 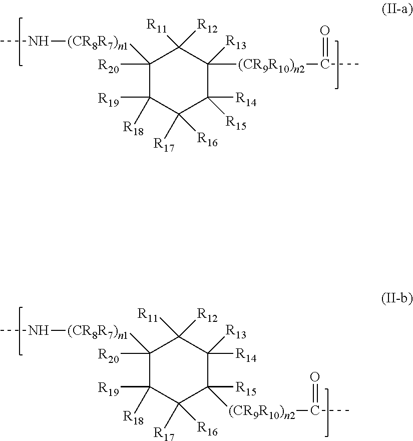
wherein
each of R₇ to R₂₀ is independently selected from hydrogen atom, halogen atom, alkyl, alkenyl, alkynyl, aryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium,
each of n1 and n2, independently, is 0 or an integer from 1 to 12; 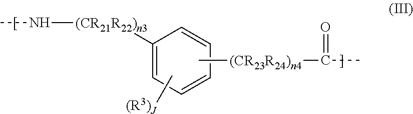
wherein
R³ is selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium,
J is 0 or an integer from 1 to 4,
each of R₂₁ to R₂₄ is independently selected from hydrogen atom, halogen atom, alkyl, alkenyl, alkynyl, aryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium,
each of n3 and n4, independently, is 0 or an integer from 1 to 15.

8. The polymer (PA) according to claim 7, wherein said recurring unit of formula [R_{PA}] complies with formulae (II-a) or (II-b): 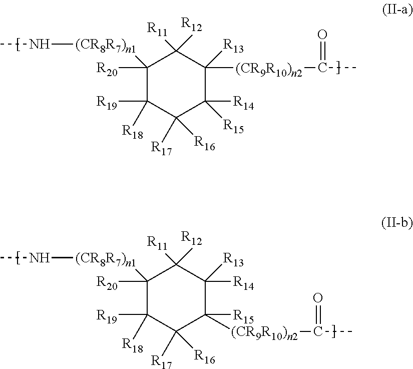
wherein
each of R₇ to R₂₀ is independently selected from hydrogen atom, halogen atom, alkyl group comprising from 1 to 3 carbon atoms and each of n1 and n2, independently, is 0 or an integer from 1 to 3.

9. The polymer (PA) according to claim 8, wherein in said formulae (II-a) or (II-b), each of R₇ to R₂₀ is hydrogen atom, n1 is 1 and n2 is 0.

10. The polymer (PA) according to claim 7, wherein said recurring unit of formula [R_{PA}] complies with formula (III): 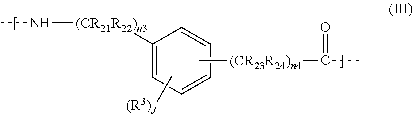
wherein R³ is selected from hydrogen atom, halogen atom, alkyl group comprising from 1 to 3 carbon atoms, J is 0 or an integer from 1 to 4, each of R₂₁ to R₂₄ is independently selected from hydrogen atom, halogen atom, alkyl group comprising from 1 to 3 carbon atoms, and each of n3 and n4, independently, is 0 or an integer from 1 to 3.

11. The polymer (PA) according to claim 10, wherein in said formula (III), R³ is selected from hydrogen atom, halogen atom, alkyl group comprising from 1 to 3 carbon atoms, J is 0 or an integer from 1 to 4, n3 is 1, R₂₁ and R₂₂ are hydrogen atoms and n4 is 0.

12. A composition [composition (C)] comprising at least one polymer (PA) as defined in claim 1, and at least one additional ingredient selected from reinforcing fibres and additives.

13. The composition (C) according to claim 12, wherein said reinforcing fibers are selected from the group consisting of carbon fibers, continuous or chopped glass fibers, synthetic polymeric fibres, aluminium fibres, aluminium silicate fibres, titanium fibres, steel fibres, silicon carbide fibres and boron fibers; and wherein said additives are selected from the group consisting of: UV stabilizers, heat stabilizers, pigments, dyes, flame retardants, impact modifiers, processing aids, nucleating agents, mineral fillers, and mixtures thereof.

14. The composition (C) according to claim 12, said composition (C) comprising from 10 to 99.9 wt. % of the at least one polymer (PA) based on the total weight of the composition (C).

15. An article comprising the polymer (PA) according to claim 1 or a composition (C) comprising the polymer (PA) and at least one additional ingredient selected from reinforcing fibres and additives.

16. A thermoplastic composite comprising the polymer (PA) according to claim 1 and continuous and/or non-continuous fibres.

17. The thermoplastic composite according to claim 16, wherein the continuous and/or non-continuous fibres are glass fibres and/or carbon fibers.

18. The polymer (PA) according to claim 3, said polymer (PA) comprising from 10 to 40 mol. % of said recurring units [R_{INP}], the amount being relative to the total number of moles of recurring units in the polymer (PA).

19. The polymer (PA) according to claim 5, said polymer (PA) comprising from 60 to 90 mol. % of said at least one recurring unit [R_{PA}], the amount being relative to the total number of moles of recurring units in the polymer (PA).
